(19) United States
(12) Patent Application Publication
(10) Pub. No.: US 2022/0128799 A1
(43) Pub. Date: Apr. 28, 2022

(54) OPTICAL LENS

(71) Applicant: ABILITY ENTERPRISE CO., LTD., New Taipei City (TW)

(72) Inventor: Jung-Yao CHEN, New Taipei City (TW)

(21) Appl. No.: 17/364,492

(22) Filed: Jun. 30, 2021

(30) Foreign Application Priority Data
Oct. 28, 2020 (TW) 109137408

(51) Int. Cl. G02B 13/00; G02B 9/64; G02B 27/00

(52) U.S. Cl. CPC G02B 13/0045; G02B 27/005; G02B 9/64

(57) ABSTRACT

An optical lens, in order from an object side to an image-forming side, includes: a first lens, a second lens and a third lens which have refractive power, a fourth lens having positive refractive power, a fifth lens, a sixth lens and a seventh lens which have refractive power, an eighth lens having negative refractive power, a ninth lens and a tenth lens which have refractive power. The optical lens satisfies at least one of the following conditions: an overall optical effect of the first lens, the second lens and the third lens is negative refractive power; an overall optical effect of the fifth lens and the sixth lens is negative refractive power; an overall optical effect of the fifth lens, the sixth lens and the seventh lens is positive refractive power; and an overall optical effect of the ninth lens and the tenth lens is positive refractive power.

This application claims the benefit of Taiwan application Serial No. 109137408, filed Oct. 28, 2020, the subject matter of which is incorporated by reference herein in its entirety.

### TECHNICAL FIELD

The invention relates in general to an optical lens, and more particularly to an optical lens with low chromatic dispersion, low distortion and small size.

### BACKGROUND

In recent years, with the rise of outdoor image capturing device, the demand for optical lens which provides stable image quality even in the outdoors for a long period of time has also increased significantly. However, for most of the image capturing devices, the problem of degradation of image quality caused by the change of refractive index of environmental media cannot be overcome; on the other hand, most of the image capturing devices always increase the brightness of images by extending the sensitivity time and/or increasing the sensitivity in the low background light or night photography environment, resulting in too much noise in the images taken in the dim environment, which not only cannot achieve good photographic performances, but also let the user cannot keep the good memories. Therefore, there is an urgent need to propose a new optical lens which may simultaneously meet the requirements of low chromatic dispersion, low distortion and small size, and also obtain the image in low light environment the same as being taken in normal light environment.

### SUMMARY

The invention is directed to an optical lens having the characteristics of low chromatic dispersion, low distortion and small size, and achieving excellent photographic performances in low background light or night environment, so as to realize day-and-night confocal effect.

According to one embodiment, an optical lens is provided. The optical lens, in order from an object side to an image-forming side, includes a first lens having refractive power, a second lens having refractive power, a third lens having refractive power, a fourth lens having positive refractive power, a fifth lens having refractive power, a sixth lens having refractive power, a seventh lens having refractive power, an eighth lens having negative refractive power, a ninth lens having refractive power and a tenth lens having refractive power. The optical lens satisfies at least one of the following conditions: an overall optical effect of the first lens, the second lens and the third lens is negative refractive power; an overall optical effect of the fifth lens and the sixth lens is negative refractive power; an overall optical effect of the fifth lens, the sixth lens and the seventh lens is positive refractive power; and an overall optical effect of the ninth lens and the tenth lens is positive refractive power.

According to another embodiment, an optical lens is provided. The optical lens, in order from an object side to an image-forming side, includes a first lens having negative refractive power, a second lens having negative refractive power, a third lens having negative refractive power, a fourth lens having positive refractive power, a fifth lens having positive refractive power, a sixth lens having negative refractive power, a seventh lens having positive refractive power, an eighth lens having negative refractive power, a ninth lens having positive refractive power and a tenth lens having positive refractive power.

According to still another embodiment, an optical lens is provided. The optical lens, in order from an object side to an image-forming side, includes a first lens having negative refractive power, a second lens having negative refractive power, a third lens having negative refractive power, a fourth lens having positive refractive power, a fifth lens having refractive power, a sixth lens having refractive power, a seventh lens having refractive power, an eighth lens having negative refractive power, a ninth lens having positive refractive power and a tenth lens having positive refractive power. The optical lens satisfies at least one of the following conditions: the fifth lens and the sixth lens compose a cemented lens having negative refractive power; the fifth lens, the sixth lens and the seventh lens compose a cemented lens having positive refractive power; the sixth lens, the seventh lens and the eighth lens compose a cemented lens having negative refractive power; and the seventh lens and the eighth lens compose a cemented lens having positive refractive power.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an optical lens according to one embodiment of the present invention.

FIG. 2 is a schematic diagram of an optical lens according to another embodiment of the present invention.

FIG. 3A lists each lens parameter of the optical lens shown in FIG. 1 according to one embodiment of the present invention.

FIG. 3B lists aspheric coefficients of the mathematic equation of the aspheric lens of the optical lens of FIG. 1 according to one embodiment of the present invention.

FIG. 4A lists each lens parameter of the optical lens shown in FIG. 2 according to one embodiment of the present invention.

FIG. 4B lists aspheric coefficients of the mathematic equation of the aspheric lens of the optical lens of FIG. 2 according to one embodiment of the present invention.

FIG. 5 is a schematic diagram of an optical lens according to still another embodiment of the present invention.

FIG. 6 is a schematic diagram of an optical lens according to a further embodiment of the present invention.

FIG. 7 lists each lens parameter of the optical lens shown in FIG. 5 according to one embodiment of the present invention.

FIG. 8 lists each lens parameter of the optical lens shown in FIG. 6 according to one embodiment of the present invention.

FIG. 9 lists the specific parameters of the optical lenses of FIGS. 3A, 4A, 7 and 8.

### DETAILED DESCRIPTION

Each embodiment of the present invention will be described in detail hereinafter, and illustrated with the accompanying drawings. In addition to these detailed descriptions, the present invention may be broadly practiced in other embodiments, and any substitution, modification, or equivalent variation of any of the described embodiments is included within the scope of the present invention, subject to the scope of the claims thereafter. In the description of the specification, many specific details are provided in order to give the reader a more complete understanding of the present invention; however, the present invention may be practiced with the omission of some or all of these specific details. In addition, well-known steps or elements are not described in detail to avoid unnecessary limitations of the present invention. Identical or similar elements in the drawings will be indicated by identical or similar reference numerals. In particular, the drawings are only for illustrative purposes and do not represent the actual size or number of elements, unless they are otherwise indicated.

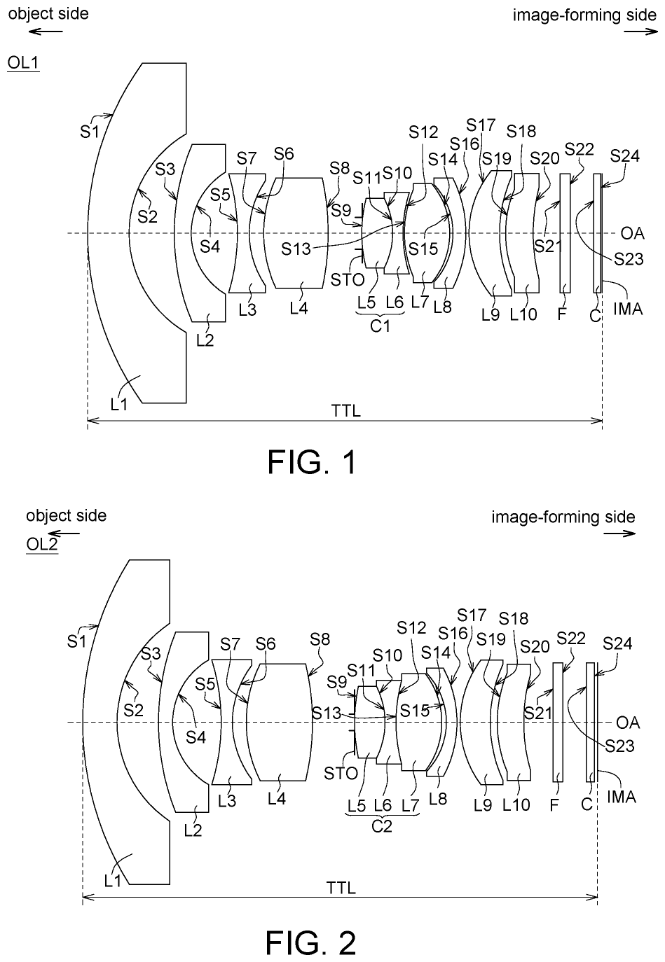

FIG. 1 is a schematic diagram of an optical lens OL1 according to one embodiment of the present invention. FIG. 2 is a schematic diagram of an optical lens OL2 according to another embodiment of the present invention. In order to show the features of the embodiments, only the structures related to the embodiments of the present invention are shown and the rest of the structures are omitted.

The optical lens OL1, OL2 may be a fixed-focus lens or a zoom lens having the characteristics of low chromatic dispersion, low distortion and small size and achieving excellent photographic performances in low background light or night environment. The optical lens OL1, OL2 may be applied to a device capable of image projection or image capture, the device including but not limited to a handheld computer system, a handheld communication system, an aerial camera, a sports camera lens, a camera lens for vehicle, a surveillance system, an internet protocol camera, a digital camera, a digital video camera or a projector.

Referring to FIG. 1 and FIG. 2, the left side is the object side and the right side is the image-forming side. The light beam may penetrate each lens of the optical lens OL1, OL2 from the object side and may be imaged on an imaging plane IMA on the image-forming side. The optical lens OL1, OL2, in order from the object side to the image-forming side, may include a first lens L1, a second lens L2, a third lens L3, a fourth lens L4, a fifth lens L5, a sixth lens L6, a seventh lens L7, an eighth lens L8, a ninth lens L9 and a tenth lens L10. The above ten lenses may be arranged along an optical axis OA. The first lens L1, the second lens L2, the third lens L3, the fourth lens L4, the fifth lens L5, the sixth lens L6, the seventh lens L7, the eighth lens L8, the ninth lens L9 and the tenth lens L10 may have refractive power, respectively.

In some embodiments, the first lens L1 may have negative refractive power; the second lens L2 may have negative refractive power; the third lens L3 may have negative refractive power; the fourth lens L4 may have positive refractive power; the fifth lens L5 may have positive refractive power; the sixth lens L6 may have negative refractive power; the seventh lens L7 may have positive refractive power; the eighth lens L8 may have negative refractive power; the ninth lens L9 may have positive refractive power; the tenth lens L10 may have positive refractive power.

In some embodiments, an overall optical effect of the first lens L1, the second lens L2 and the third lens L3 may be negative refractive power; in some other embodiments, an overall optical effect of the ninth lens L9 and the tenth lens L10 may be positive refractive power; in some still other embodiments, an overall optical effect of the fifth lens L5 and the sixth lens L6 may be negative refractive power; in some further embodiments, an overall optical effect of the fifth lens L5, the sixth lens L6 and the seventh lens L7 may be positive refractive power.

Moreover, the optical lens OL1, OL2 may include a cemented lens. In some embodiments, the fifth lens L5 and the sixth lens L6 may be combined together to form a cemented lens C1; in some specific embodiments, the cemented lens C1 may have negative refractive power. In some other embodiments, the cemented lens C1 and the seventh lens L7 may be combined together to form a cemented lens C2, that is, the fifth lens L5, the sixth lens L6 and the seventh lens L7 may be combined together to form the cemented lens O2; in some specific embodiments, the cemented lens C2 may have positive refractive power. In some still other specific embodiments, the cemented lens C1 has a refractive power of D1, and −28≤D1≤−12; in some further specific embodiments, the cemented lens C2 has a refractive power of D2, and 0<D2≤15, but the present invention is not limited thereto.

In some embodiments, the optical lens OL1, OL2 has a field of view of FOV, and the optical lens OL1, OL2 may satisfy at least one of the following conditions: 90°≤FOV, 100°≤FOV, 110°≤FOV, 120°≤FOV, FOV≤160°, FOV≤170°, FOV≤180° and FOV≤190°.

In some embodiments, TTL is the distance between an object-side surface S1 of the first lens L1 and the imaging plane IMA, F is the focal length of the optical lens OL1, OL2, and the optical lens OL1, OL2 may satisfy at least one of the following conditions: 8≤TTL/F, 9≤TTL/F, 10≤TTL/F, 11≤TTL/F, 11.5≤TTL/F, TTL/F≤14, TTL/F≤15 and TTL/F≤16.

The incident beam passing through the first lens L1, second lens L2, third lens L3, fourth lens L4, fifth lens L5, sixth lens L6, seventh lens L7, eighth lens L8, ninth lens L9 and tenth lens L10 of the optical lens OL1, OL2 may be converged to the imaging plane IMA. In some embodiments, Y′ is the image height of an object on the imaging plane IMA, and the optical lens OL1, OL2 may satisfy at least one of the following conditions: 0.65≤F/Y′, 0.67≤F/Y′, 0.7≤F/Y′, F/Y′≤0.75, F/Y′≤0.78 and F/Y′≤0.8.

In some embodiments, the optical lens OL1, OL2 may further include a stop STO, Fno is the F-number of the stop STO, and the optical lens OL1, OL2 may satisfy at least one of the following conditions: 0.05≤(Fno*TTL)/(FOV*Y′), 0.08≤(Fno*TTL)/(FOV*Y′), 0.1≤(Fno*TTL)/(FOV*Y′), (Fno*TTL)/(FOV*Y′)≤0.15, (Fno*TTL)/(FOV*Y′)≤0.18, (Fno*TTL)/(FOV*Y′)≤0.2, (Fno*TTL)/(FOV*Y′)≤0.25 and (Fno*TTL)/(FOV*Y′)≤0.3.

In some embodiments, R1 is a curvature radius of the object-side surface S1 of the first lens L1, R2 is a curvature radius of an image-side surface S2 of the first lens L1, and the optical lens OL1, OL2 may satisfy at least one of the following conditions: 0<|(R1−R2)/(R1+R2)|, 0.2≤1(R1−R2)/(R1+R2)|, 0.3≤1(R1−R2)/(R1+R2)|, 0.35≤1(R1−R2)/(R1+R2)|, |(R1−R2)/(R1+R2)|≤0.45, |(R1−R2)/(R1+R2)|≤0.5, |(R1−R2)/(R1+R2)|≤0.75, |(R1−R2)/(R1+R2)|≤0.8, |(R1−R2)/(R1+R2)|≤0.9 and |(R1−R2)/(R1+R2)|<1.

In some specific embodiments, R1 is a curvature radius of the object-side surface S1 of the first lens L1, R2 is a curvature radius of the image-side surface S2 of the first lens L1, and the optical lens OL1, OL2 may satisfy at least one of the following conditions: 0<(R1−R2)/(R1+R2), 0.2≤(R1−R2)/(R1+R2), 0.3≤(R1−R2)/(R1+R2), 0.35≤(R1−R2)/(R1+R2), (R1−R2)/(R1+R2)≤0.45, (R1−R2)/(R1+R2)≤0.5, (R1−R2)/(R1+R2)≤0.75, (R1−R2)/(R1+R2)≤0.8, (R1−R2)/(R1+R2)≤0.9 and (R1−R2)/(R1+R2)<1.

Furthermore, the third lens L3 has a refractive index of N3 and an Abbe number of V3, the fifth lens L5 has a refractive index of N5 and an Abbe number of V5, the seventh lens L7 has a refractive index of N7 and an Abbe number of V7, the ninth lens L9 has a refractive index of N9 and an Abbe number of V9; the fourth lens L4 has a refractive index of N4 and an Abbe number of V4, the sixth lens L6 has a refractive index of N6 and an Abbe number of V6, the eighth lens L8 has a refractive index of N8 and an Abbe number of V8.

In some embodiments, at least one of the refractive indexes N3, N5, N7 and N9 of the third lens L3, the fifth lens L5, the seventh lens L7 and the ninth lens L9 is Nk, and the optical lens OL1, OL2 may satisfy at least one of the following conditions: 1.4≤Nk, 1.43≤Nk, 1.48≤Nk, Nk≤1.61, Nk≤1.63 and Nk<1.65.

In some embodiments, at least one of the Abbe numbers V3, V5, V7 and V9 of the third lens L3, the fifth lens L5, the seventh lens L7 and the ninth lens L9 is Vk, and the optical lens OL1, OL2 may satisfy at least one of the following conditions: 50≤Vk, 55≤Vk, 60≤Vk, 65≤Vk, Vk≤85, Vk≤90 and Vk≤95.

In some embodiments, at least one of the refractive indexes N4, N6 and N8 of the fourth lens L4, the sixth lens L6 and the eighth lens L8 is Nf, and the optical lens OL1, OL2 may satisfy at least one of the following conditions: 1.65<Nf, 1.67≤Nf, Nf≤1.85 and Nf≤2.

In some embodiments, at least one of the Abbe numbers V4, V6 and V8 of the fourth lens L4, the sixth lens L6 and the eighth lens L8 is Vf, and the optical lens OL1, OL2 may satisfy at least one of the following conditions: 15≤Vf, 18≤Vf, Vf≤38, Vf≤45 and Vf≤48.

In some embodiments, the first lens L1, the second lens L2, the third lens L3, the fourth lens L4, the fifth lens L5, the sixth lens L6, the seventh lens L7, the eighth lens L8, the ninth lens L9 and the tenth lens L10 may respectively be a spherical lens or an aspheric lens.

Specifically, each aspheric lens has at least one aspheric surface, that is, the object-side surface and/or the image-side surface of the aspheric lens are/is the aspheric surface(s). And, each of the aspheric surfaces may satisfy the following mathematic equation:

$$Z = [ \frac{( C \times {Y}^{2} )}{1 \sqrt{1 - ( K + 1 ) {C}^{2} {Y}^{2}}} ] + \sum ( {A}_{i} \times {Y}_{i} )$$

Z is the coordinate in the direction of the optical axis OA, and the direction in which light propagates is designated as positive; A₂, A₄, A₆, A₈ and A₁₀ are aspheric coefficients; K is coefficient of quadratic surface; C is reciprocal of R (C=1/R); R is the curvature radius; Y is the coordinate in a direction perpendicular to the optical axis OA, in which the upward direction away from the optical axis OA is designated as positive. In addition, each of the parameters or the coefficients of the equation of each aspheric lens may be designated respectively to determine the focal length of each aspheric lens.

In some embodiments, at least one of the first lens L1 to the tenth lens L10 may be a spherical lens or an aspheric lens. In one specific embodiment, the first lens L1 to the ninth lens L9 are spherical lenses, and the tenth lens L10 is an aspheric lens. In some specific embodiments, the first lens L1 to the ninth lens L9 may be spherical lenses with object-side surfaces S1, S3, S5, S7, S9, S11, S13, S15, S17 and image-side surfaces S2, S4, S6, S8, S10, S12, S14, S16, S18 all being spherical surfaces, the tenth lens L10 may be an aspheric lens with object-side surface S19 and image-side surface S20 both being aspheric surfaces.

Furthermore, in some embodiments, the first lens L1 to the tenth lens L10 may respectively be a glass lens made of a glass material or a plastic lens made of a plastic material. The material of the plastic lens may include, but not limit to, polycarbonate, cyclic olefin copolymer (e.g. APEL), polyester resins (e.g. OKP4 or OKP4HT) and so on, or a mixture and/or a compound material including at least one of the above-mentioned three materials. In some specific embodiments, the first lens L1 to the ninth lens L9 are glass lenses, and the tenth lens L10 is a plastic lens; in some other specific embodiments, the first lens L1 to the tenth lens L10 are all glass lenses, but the present invention is not limited thereto.

Referring to FIG. 1 and FIG. 2, in some embodiments, the object-side surfaces S1, S3 of the first lens L1 and the second lens L2 may be convex surfaces protruding toward the object side, having positive refractive rate; the image-side surfaces S2, S4 of the first lens L1 and the second lens L2 may be concave surfaces recessed toward the object side, having positive refractive rate. The first lens L1 and the second lens L2 may respectively be a lens having negative refractive power, the lens including but not limited to any one of a convex-concave lens, a glass lens or a plastic lens, and a spherical lens or an aspheric lens having negative refractive power, or a combination thereof.

The object-side surfaces S5, S11 of the third lens L3 and the sixth lens L6 may be concave surfaces recessed toward the image-forming side, having negative refractive rate; the image-side surfaces S6, S12 of the third lens L3 and the sixth lens L6 may be concave surfaces recessed toward the object side, having positive refractive rate. The third lens L3 and the sixth lens L6 may respectively be a lens having negative refractive power, the lens including but not limited to any one of a biconcave lens, a glass lens or a plastic lens, and a spherical lens or an aspheric lens having negative refractive power, or a combination thereof.

The object-side surfaces S7, S9, S13 of the fourth lens L4, the fifth lens L5 and the seventh lens L7 may be convex surfaces protruding toward the object side, having positive refractive rate; the image-side surfaces S8, S10, S14 the fourth lens L4, the fifth lens L5 and the seventh lens L7 may be convex surfaces protruding toward the image-forming side, having negative refractive rate. The fourth lens L4, the fifth lens L5 and the seventh lens L7 may respectively be a lens having positive refractive power, the lens including but not limited to any one of a biconvex lens, a glass lens or a plastic lens, and a spherical lens or an aspheric lens having positive refractive power, or a combination thereof.

The object-side surface S15 of the eighth lens L8 may be a concave surface recessed toward the image-forming side, having negative refractive rate; the image-side surface S16 may be a convex surfaces protruding toward the image-forming side, having negative refractive rate. The eighth lens L8 may be a lens having negative refractive power, the lens including but not limited to any one of a concave-convex lens, a glass lens or a plastic lens, and a spherical lens or an aspheric lens having negative refractive power, or a combination thereof.

The object-side surfaces S17, S19 of the ninth lens L9 and the tenth lens L10 may be convex surfaces protruding toward the object side, having positive refractive rate; the image-side surfaces S18, S20 of the ninth lens L9 and the tenth lens L10 may be concave surfaces recessed toward the object side, having positive refractive rate. The ninth lens L9 and the tenth lens L10 may respectively be a lens having positive refractive power, the lens including but not limited to any one of a convex-concave lens, a glass lens or a plastic lens, and a spherical lens or an aspheric lens having positive refractive power, or a combination thereof.

In some embodiments, the optical lens OL1, OL2 may further include a stop STO; in another embodiment, an image capturing unit (not shown) may be further disposed on the imaging plane IMA for photo-electrically converting light beams passing through the optical lens OL1, OL2. The stop STO may be arranged on the object side of the first lens L1, arranged in any interval between any two of the first lens L1 to the tenth lens L10, or arranged between the tenth lens L10 and the imaging plane IMA. In one specific embodiment, the stop STO is arranged between the fourth lens L4 and the fifth lens L5, but the present invention is not limited thereto.

Furthermore, the optical lens OL1, OL2 may further include a filter F and/or a protection film C. In one embodiment, the filter F may be arranged between the tenth lens L10 and the imaging plane IMA. In one specific embodiment, the filter F may be an IR filter; in another embodiment, the protection film C may be arranged between the filter F and the imaging plane IMA, and a filter film (not shown) may be further formed on the protection film C; in still another embodiment, only the protection film C integrating the functions of protecting the image capturing unit and filtering the infrared light may be used.

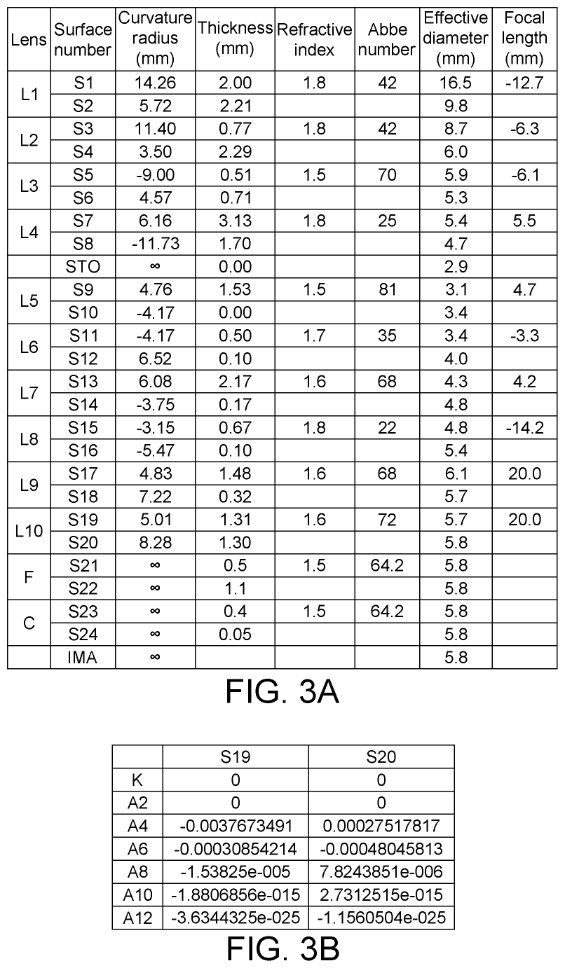

FIG. 3A lists each lens parameter of the optical lens OL1 shown in FIG. 1 according to one embodiment of the present invention, including the curvature radius, the thickness, the refractive index, the Abbe number (coefficient of chromatic dispersion), the effective diameter, the focal length and so on of each lens. The surface numbers of the lenses are sequentially ordered from the object side to the image-forming side. For example, “STO” stands for the stop STO, “S1” stands for the object-side surface S1 of the first lens L1, “S2” stands for the image-side surface S2 of the first lens L1, . . . , “S21” and “S22” respectively stand for the object-side surface S21 and the image-side surface S22 of the filter F, “S23” and “S24” respectively stand for the object-side surface S23 and the image-side surface S24 of the protection film C, and so on. In addition, the “thickness” stands for the distance between an indicated surface and an adjacent surface close to the image-forming side. For example, the “thickness” of the object-side surface S1 is the distance between the object-side surface S1 and the image-side surface S2 of the first lens L1; the “thickness” of the image-side surface S2 is the distance between the image-side surface S2 of the first lens L1 and the object-side surface S3 of the second lens L2. The cemented lens C1 of the present embodiment has a refractive power of D3, which is −19.38±0.2.

FIG. 3B lists aspheric coefficients of the mathematic equation of the aspheric lens of the optical lens OL1 of FIG. 1 according to one embodiment of the present invention. If the object-side surface S19 and the image-side surface S20 of the tenth lens L10 of the optical lens OL1 are aspheric surfaces, each aspheric coefficient for the mathematic equation may be listed as indicated in FIG. 3B.

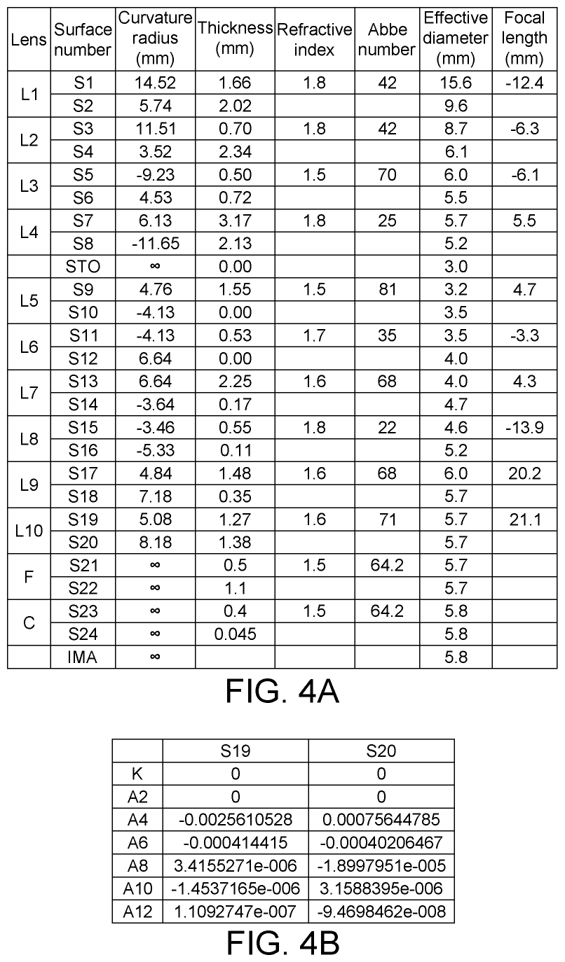

FIG. 4A lists each lens parameter of the optical lens OL2 shown in FIG. 2 according to one embodiment of the present invention, which represents approximately the same definition and meaning as in FIG. 3A. The cemented lens C2 of the present embodiment has a refractive power of D4, which is 6.05±0.2.

FIG. 4B lists aspheric coefficients of the mathematic equation of the aspheric lens of the optical lens OL2 of FIG. 2 according to one embodiment of the present invention. If the object-side surface S19 and the image-side surface S20 of the tenth lens L10 of the optical lens OL2 are aspheric surfaces, each aspheric coefficient for the mathematic equation may be listed as indicated in FIG. 4B.

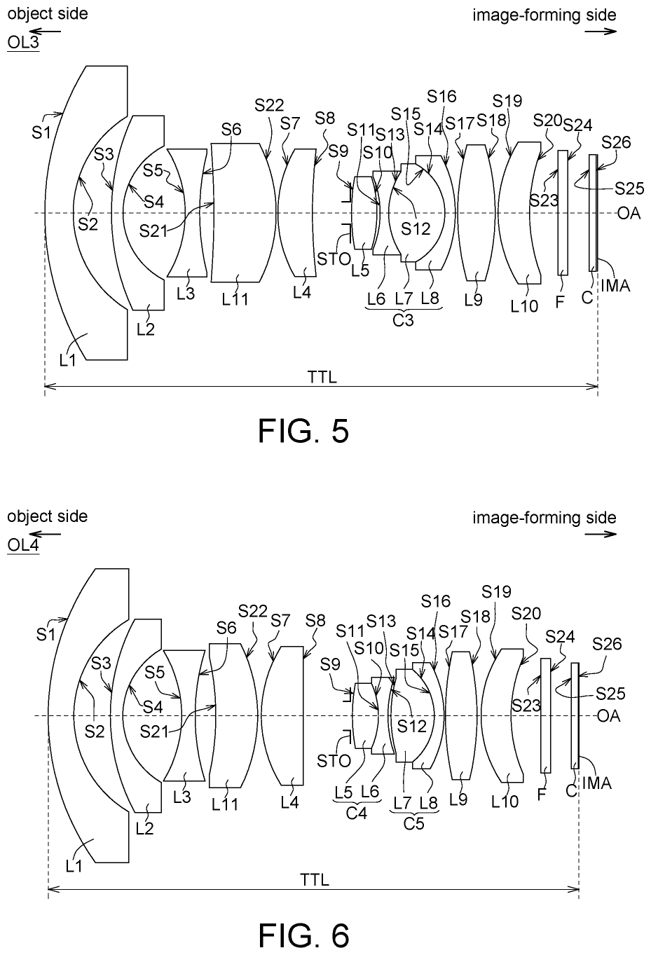

FIG. 5 is a schematic diagram of an optical lens OL3 according to still another embodiment of the present invention FIG. 6 is a schematic diagram of an optical lens OL4 according to a further embodiment of the present invention. As shown in FIG. 5 and FIG. 6, the optical lens OL3, OL4 is generally similar to the optical lens OL1, OL2, and generally the same reference numerals are used for indicating the elements. The main difference between the optical lens OL3, OL4 and the optical lens OL1, OL2 is that: the optical lens OL3, OL4 further includes an eleventh lens L11 disposed between the third lens L3 and the fourth lens L4.

Referring to FIG. 5 and FIG. 6, in some embodiments, the eleventh lens L11 may have refractive power. The object-side surface S21 of the eleventh lens L11 may be a concave surface recessed toward the image-forming side, having negative refractive rate; the image-side surface S22 may be a convex surfaces protruding toward the image-forming side, having negative refractive rate. The eleventh lens L11 may be a lens having positive refractive power, the lens including but not limited to any one of a concave-convex lens, a glass lens or a plastic lens, and a spherical lens or an aspheric lens having positive refractive power, or a combination thereof.

Referring to FIG. 5, specifically, the object-side surface S7 of the fourth lens L4 of the optical lens OL3 may be a convex surface protruding toward the object side, having positive refractive rate; the image-side surfaces S8 may be a concave surface recessed toward the object side, having positive refractive rate. The fourth lens L4 of the optical lens OL3 may be any one of a convex-concave lens, a glass lens or a plastic lens, and a spherical lens or an aspheric lens having positive refractive power, or a combination thereof.

Referring to FIG. 6, on the other hand, the object-side surface S7 of the fourth lens L4 of the optical lens OL4 may be a convex surface protruding toward the object side, having positive refractive rate; the image-side surfaces S8 may be a convex surface protruding toward the image-forming side, having negative refractive rate. The fourth lens L4 of the optical lens OL4 may be any one of a biconvex lens, a glass lens or a plastic lens, and a spherical lens or an aspheric lens having positive refractive power, or a combination thereof.

In addition, as shown in FIG. 5 and FIG. 6, the object-side surface S17 of the ninth lens L9 of the optical lens OL3, OL4 may be a convex surface protruding toward the object side, having positive refractive rate; the image-side surfaces S18 may be a convex surface protruding toward the image-forming side, having negative refractive rate. The ninth lens L9 of the optical lens OL3, OL4 may be a lens having positive refractive power, the lens including but not limited to any one of a biconvex lens, a glass lens or a plastic lens, and a spherical lens or an aspheric lens having positive refractive power, or a combination thereof.

Besides, in some embodiments, an overall optical effect of the eleventh lens L11 and the fourth lens L4 of the optical lens OL3, OL4 is positive refractive power.

In some embodiments, the value of the refractive index N11 of the eleventh lens L11 may also be Nf, the value of the Abbe number V11 may also be Vf, and the eleventh lens L11 may also satisfy at least one of the following conditions: 1.65<Nf, 1.67≤Nf, Nf≤1.85, Nf≤2, 15≤Vf, 18≤Vf, Vf≤38, Vf≤45 and Vf≤48.

In some embodiments, the sixth lens L6, the seventh lens L7 and the eighth lens L8 of the optical lens OL3, OL4 may be combined together to form a cemented lens O3; in some specific embodiments, the cemented lens C3 may have negative refractive power. In some other embodiments, the fifth lens L5 and the sixth lens L6 may be combined together to form a cemented lens O4; in some specific embodiments, the cemented lens C4 may have negative refractive power. In some still other embodiments, the seventh lens L7 and the eighth lens L8 may be combined together to form a cemented lens O5; in some specific embodiments, the cemented lens C5 may have positive refractive power. In some other specific embodiments, the cemented lens C3 has a refractive power of D3, and −18≤D3<0; in some still other specific embodiments, the cemented lens C4 has a refractive power of D4, and −15≤D4<0; in some further specific embodiments, the cemented lens C5 has a refractive power of D5, and 0<D5≤15, but the present invention is not limited thereto.

In some embodiments, at least one of the first lens L1 to the eleventh lens L11 of the optical lens OL3, OL4 may be a spherical lens or an aspheric lens. In one specific embodiment, the first lens L1 to the eleventh lens L11 are spherical lenses, but the present invention is not limited thereto.

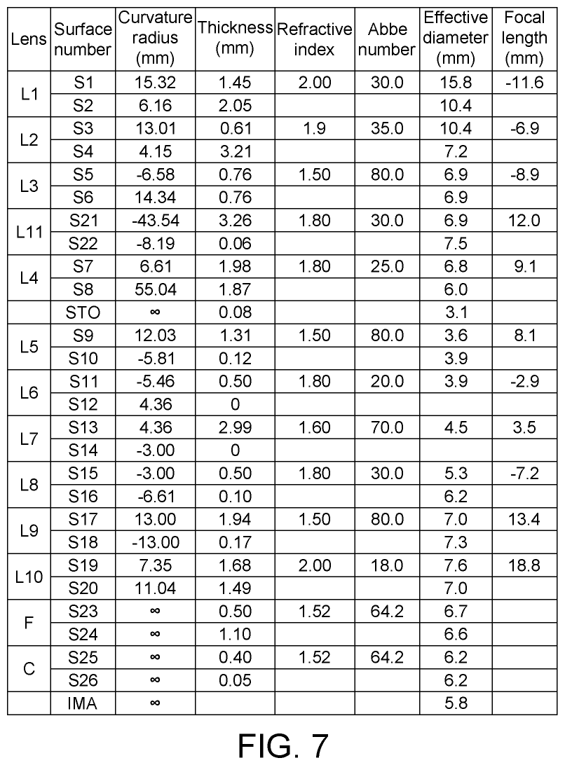

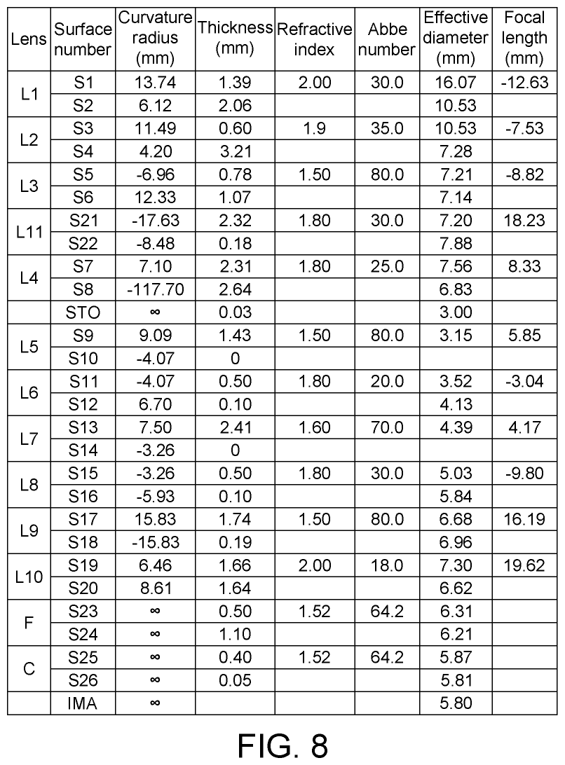

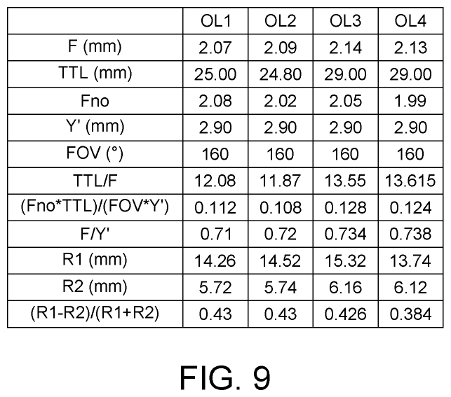

FIG. 7 lists each lens parameter of the optical lens OL3 shown in FIG. 5 according to one embodiment of the present invention. FIG. 8 lists each lens parameter of the optical lens OL4 shown in FIG. 6 according to one embodiment of the present invention. Each lens parameter represents approximately the same definition and meaning as in FIG. 3A. The cemented lens C3 of the optical lens OL3 as listed in the embodiment of FIG. 7 has a refractive power of D3, which is −8.97±0.2; the cemented lens C4 of the optical lens OL4 as listed in the embodiment of FIG. 8 has a refractive power of D4, which is −7.5±0.2, and the cemented lens C5 has a refractive power of D5, which is 6.96±0.2.

FIG. 9 lists the specific parameters of the optical lenses OL1, OL2, OL3, OL4 of FIGS. 3A, 4A, 7 and 8, including the focal length of the optical lens OL1, OL2, OL3, OL4 (F), the distance between the object-side surface S1 of the first lens L1 and the imaging plane IMA (TTL), the F-number (Fno), the image height (Y′), the field of view (FOV), the curvature radii of the object-side surface S1 and the image-side surface S2 (R1 and R2), and the values of the relations for the above parameters.

As can be seen from the above embodiments, the optical lens provided in the present invention may have the characteristics of low chromatic dispersion, low distortion and small size.

It will be apparent to those skilled in the art that various modifications and variations can be made to the disclosed embodiments. It is intended that the specification and examples be considered as exemplary only, with a true scope of the invention being indicated by the following claims and their equivalents.

What is claimed is:

1. An optical lens, in order from an object side to an image-forming side, comprising:
a first lens having negative refractive power;
a second lens having negative refractive power;
a third lens having negative refractive power;
a fourth lens having positive refractive power;
a fifth lens having positive refractive power;
a sixth lens having negative refractive power;
a seventh lens having positive refractive power;
an eighth lens having negative refractive power;
a ninth lens having positive refractive power; and
a tenth lens having positive refractive power.

2. The optical lens according to claim 1, wherein at least one of the third lens, the fifth lens, the seventh lens and the ninth lens has a refractive index of Nk; at least one of the third lens, the fifth lens, the seventh lens and the ninth lens has an Abbe number of Vk; at least one of the fourth lens, the sixth lens and the eighth lens has a refractive index of Nf; at least one of the fourth lens, the sixth lens and the eighth lens has an Abbe number of Vf, and the optical lens satisfies at least one of the following conditions: Nk<1.65, 50≤Vk, 1.65<Nf and Vf≤48.

3. The optical lens according to claim 1, further comprising an eleventh lens having refractive power between the third lens and the fourth lens.

4. The optical lens according to claim 3, wherein the eleventh lens has a refractive index of Nf and an Abbe number of Vf, and the eleventh lens satisfies at least one of the following conditions: 1.65<Nf and Vf≤48.

5. The optical lens according to claim 3, wherein the optical lens satisfies at least one of the following conditions:
the eleventh lens has positive refractive power; and
an overall optical effect of the eleventh lens and the fourth lens is positive refractive power.

6. The optical lens according to claim 1, wherein Fno is an F-number of the optical lens, TTL is a distance between an object-side surface of the first lens and an imaging plane, F is a focal length of the optical lens, FOV is a field of view of the optical lens, Y′ is an image height of the optical lens, and the optical lens satisfies at least one of the following conditions: 8≤TTL/F≤16, 0.65≤F/Y′≤0.8, 90°≤FOV and 0.05≤(Fno*TTL)/(FOV*Y)≤0.3.

7. The optical lens according to claim 1, wherein R1 is a curvature radius of an object-side surface of the first lens, R2 is a curvature radius of an image-side surface of the first lens, and the optical lens satisfies the condition of 0<|R1−R2|/|R1+R2|<1.

8. An optical lens, in order from an object side to an image-forming side, comprising:
a first lens having refractive power;
a second lens having refractive power;
a third lens having refractive power;
a fourth lens having positive refractive power;
a fifth lens having refractive power;
a sixth lens having refractive power;
a seventh lens having refractive power;
an eighth lens having negative refractive power;
a ninth lens having refractive power; and
a tenth lens having refractive power, and the optical lens satisfies at least one of the following conditions:
an overall optical effect of the first lens, the second lens and the third lens is negative refractive power;
an overall optical effect of the fifth lens and the sixth lens is negative refractive power;
an overall optical effect of the fifth lens, the sixth lens and the seventh lens is positive refractive power; and
an overall optical effect of the ninth lens and the tenth lens is positive refractive power.

9. The optical lens according to claim 8, wherein at least one of the third lens, the fifth lens, the seventh lens and the ninth lens has a refractive index of Nk; at least one of the third lens, the fifth lens, the seventh lens and the ninth lens has an Abbe number of Vk; at least one of the fourth lens, the sixth lens and the eighth lens has a refractive index of Nf; at least one of the fourth lens, the sixth lens and the eighth lens has an Abbe number of Vf, and the optical lens satisfies at least one of the following conditions: Nk<1.65, 50≤Vk, 1.65<Nf and Vf≤48.

10. The optical lens according to claim 8, further comprising an eleventh lens having refractive power, wherein the optical lens satisfies at least one of the following conditions:
the eleventh lens has positive refractive power;
the eleventh lens is between the third lens and the fourth lens; and
an overall optical effect of the eleventh lens and the fourth lens is positive refractive power.

11. The optical lens according to claim 10, wherein the eleventh lens has a refractive index of Nf and an Abbe number of Vf, and the eleventh lens satisfies at least one of the following conditions: 1.65<Nf and Vf≤48.

12. The optical lens according to claim 8, wherein Fno is an F-number of the optical lens, TTL is a distance between an object-side surface of the first lens and an imaging plane, F is a focal length of the optical lens, FOV is a field of view of the optical lens, Y′ is an image height of the optical lens, and the optical lens satisfies at least one of the following conditions: 8≤TTL/F≤16, 0.65≤F/Y′≤0.8, 90°≤FOV and 0.05≤(Fno*TTL)/(FOV*Y′)≤0.3.

13. The optical lens according to claim 8, wherein R1 is a curvature radius of an object-side surface of the first lens, R2 is a curvature radius of an image-side surface of the first lens, and the optical lens satisfies the condition of 0<|R1−R2|/|R1+R2|<1.

14. An optical lens, in order from an object side to an image-forming side, comprising:
a first lens having negative refractive power;
a second lens having negative refractive power;
a third lens having negative refractive power;
a fourth lens having positive refractive power;
a fifth lens having refractive power;
a sixth lens having refractive power;
a seventh lens having refractive power;
an eighth lens having negative refractive power;
a ninth lens having positive refractive power; and
a tenth lens having positive refractive power, and the optical lens satisfies at least one of the following conditions:
the fifth lens and the sixth lens compose a cemented lens having negative refractive power;
the fifth lens, the sixth lens and the seventh lens compose a cemented lens having positive refractive power;
the sixth lens, the seventh lens and the eighth lens compose a cemented lens having negative refractive power; and
the seventh lens and the eighth lens compose a cemented lens having positive refractive power.

15. The optical lens according to claim 14, wherein the optical lens satisfies at least one of the following conditions:
the cemented lens composed of the fifth lens and the sixth lens has a refractive power of D1 or D4, and −28≤D1≤−12 and −15≤D4<0;
the cemented lens composed of the fifth lens, the sixth lens and the seventh lens has a refractive power of D2, and 0<D2≤15;
the cemented lens composed of the sixth lens, the seventh lens and the eighth lens has a refractive power of D3, and −18≤D3<0; and
the cemented lens composed of the seventh lens and the eighth lens has a refractive power of D5, and 0<D5≤15.

16. The optical lens according to claim 14, wherein at least one of the third lens, the fifth lens, the seventh lens and the ninth lens has a refractive index of Nk; at least one of the third lens, the fifth lens, the seventh lens and the ninth lens has an Abbe number of Vk; at least one of the fourth lens, the sixth lens and the eighth lens has a refractive index of Nf; at least one of the fourth lens, the sixth lens and the eighth lens has an Abbe number of Vf, and the optical lens satisfies at least one of the following conditions: Nk<1.65, 50≤Vk, 1.65<Nf and Vf≤48.

17. The optical lens according to claim 14, further comprising an eleventh lens having refractive power, wherein the optical lens satisfies at least one of the following conditions:
the eleventh lens has positive refractive power;
the eleventh lens is between the third lens and the fourth lens; and
an overall optical effect of the eleventh lens and the fourth lens is positive refractive power.

18. The optical lens according to claim 17, wherein the eleventh lens has a refractive index of Nf and an Abbe number of Vf, and the eleventh lens satisfies at least one of the following conditions: 1.65<Nf and Vf≤48.

19. The optical lens according to claim 14, wherein Fno is an F-number of the optical lens, TTL is a distance between an object-side surface of the first lens and an imaging plane, F is a focal length of the optical lens, FOV is a field of view of the optical lens, Y′ is an image height of the optical lens, and the optical lens satisfies at least one of the following conditions: 8≤TTL/F≤16, 0.65≤F/Y′≤0.8, 90°≤FOV and 0.05≤(Fno*TTL)/(FOV*Y)≤0.3.

20. The optical lens according to claim 14, wherein R1 is a curvature radius of an object-side surface of the first lens, R2 is a curvature radius of an image-side surface of the first lens, and the optical lens satisfies the condition of 0<|R1−R2|/|R1+R2|<1.
